(19) United States
(12) Patent Application Publication
(10) Pub. No.: US 2008/0117128 A1
(43) Pub. Date: May 22, 2008

(54) Apparatus and method for driving a plasma display panel

(76) Inventors: Jung-Soo An, Suwon-si (KR); Suk-Ki Kim, Suwon-si (KR)

Correspondence Address: Robert E. Bushnell;Suite 300, 1522 K Street, N.W., Washington, DC, 20005-1202, US

(21) Appl. No.: 11/878,603

(22) Filed: Jul. 25, 2007

(30) Foreign Application Priority Data
Nov. 21, 2006 (KR) 10-2006-0115156

(51) Int. Cl. G09G 3/28

(52) U.S. Cl. 345/60

(57) ABSTRACT

An apparatus for driving a plasma display panel comprises: a plasma display panel including a plurality of scan electrodes, a plurality of sustain electrodes, and a plurality of address electrodes formed in a direction so as to cross the scan electrodes and the sustain electrodes; a plurality of scan ICs connected to each of a plurality of scan electrode groups into which the scan electrodes are classified according to specific references for controlling whether or not a driving signal is applied by means of first and second output control terminals; a plurality of first output control terminal groups for connecting a first output control terminal which is classified according to the first reference out of the specific references; a plurality of second output control terminal groups for connecting a second output control terminal which is classified according to the second reference out of the specific references; and a controller for applying a high level signal or a low level signal to a plurality of the first output control terminal groups and a plurality of the second output control terminal groups during a predetermined period out of the descent period of the reset periods of the scan electrode driving signal for at least one scan electrode group to turn on high side switches and low side switches inside the scan IC s.

### CLAIM OF PRIORITY

This application makes reference to, incorporates the same herein, and claims all benefits accruing under 35 U.S.C.§119 from an application for APPARATUS AND METHOD OF DRIVING FOR PLASMA DISPLAY PANEL earlier filed in the Korean Intellectual Property Office on the 21^{st} of Nov. 2006 and there duly assigned Serial No. 2006-0115156.

### BACKGROUND OF THE INVENTION

1. Field of the Invention

The present invention relates to a method and an apparatus for driving a plasma display panel and, more particularly, to a method and an apparatus for driving a plasma display panel in which a different driving signal is applied to every group of scan electrode lines so as to reduce an internal pressure which is applied to switches in a drive circuit when the driving signal is applied to the plasma display panel.

2. Discussion of Related Art

In a driving method which is basically used for a plasma display panel, reset, address and sustain steps are sequentially carried out in a unit subfield. All display cells have a uniform state of charge in the reset step. A predetermined wall voltage is generated in the selected display cells in the address step. The display cells, in which the wall voltage is formed in the address step, cause a sustain discharge by applying a predetermined AC voltage to all XY electrode line pairs in the sustain step. In the sustain step, plasma is formed in discharge gaps, namely gas layers of the selected display cells causing the sustain discharge, and phosphor layers are excited by ultraviolet irradiation to generate the light.

Referring to the reset step in more detail, wall charge states of the entire cells are reset by carrying out an addressing discharge in force in order to adjust charges of all of the display cells to a uniform state. A faint discharge (hereinafter, referred to as a “weak discharge”) is generated between the Y electrode and the X electrode, and between the Y electrode and the A electrode since a voltage of the Y electrode is gradually increased in the reference voltage during the ascent period of the reset period. Therefore, a (−) wall charge is formed in the Y electrode, and a (+) wall charge is formed in the X and A electrodes. In addition, if the voltage of the electrode is gradually changed, then a wall charge is formed so that the sum of the voltage, applied from the outside, and the wall voltage of the cells can be maintained in a state of a firing voltage while the weak discharge is generated in the cells.

Then, a voltage of the Y electrode descends to a GND voltage while the A electrode is maintained at the reference voltage during the descent period of the reset periods, and then the (−) wall charge formed in the Y electrode and the (+) wall charge formed in the X electrode and the A electrode are erased during a period when the weak discharge is generated between the Y electrode and the X electrode, and between the Y electrode and the A electrode as the voltage of the Y electrode is decreased. The wall charge conditions are adjusted to the uniform state in all of the cells through the procedures.

However, the problem is that an internal pressure which is a voltage that switches endure is increased due to the sudden change in the voltage during the descent period of the reset periods, the switches constituting the drive circuit. Accordingly, the increase in the internal pressure results in an increase in the expense required for the elements used as the switches, and additionally in an increase in EMI (electromagnetic interference).

### SUMMARY OF THE INVENTION

Accordingly, the present invention is designed to solve such drawbacks of the prior art, and therefore an object of the present invention is to provide an apparatus and a method for driving a plasma display panel in which a descending type of voltage is differently formed during the descent period of the reset signals by controlling a signal value, applied from an OC (output control) terminal of a scan IC, for every scan electrode line group.

One embodiment of the present invention is achieved by providing an apparatus for driving a plasma display panel including: a plurality of scan electrodes, a plurality of sustain electrodes, and a plurality of address electrodes formed in a direction to be crossed with the scan electrodes and the sustain electrodes; a plurality of scan ICs connected to each of a plurality of scan electrode groups into which the scan electrodes are classified according to specific references, and controlling whether or not a driving signal is applied by means of first and second output control terminals; a plurality of first output control terminal groups for connecting the first output control terminal which is classified according to the first reference out of the specific references; a plurality of second output control terminal groups for connecting the second output control terminal which is classified according to the second reference out of the specific references; and a controller for applying a high level signal or a low level signal to a plurality of the first output control terminal groups and a plurality of the second output control terminal groups during a predetermined period out of the descent period of the reset periods of the scan electrode driving signal for at least one scan electrode group to turn on high side switches and low side switches inside the scan ICs.

Another embodiment of the present invention is achieved by providing a method for driving a plasma display panel, the method including the steps of: connecting a plurality of scan electrode groups with a plurality of scan ICs, the scan electrode groups being classified according to specific references in the plasma display panel; setting a plurality of first output control terminal groups for connecting the first output control terminal in the scan ICs which is classified according to the first reference out of the specific references; setting a plurality of second output control terminal groups for connecting the second output control terminal in the scan ICs which is classified according to the second reference out of the specific references; and applying a high level signal or a low level signal to a plurality of the first output control terminal groups and a plurality of the second output control terminal groups during a predetermined period out of the descent period of the reset periods of the scan electrode driving signal for at least one scan electrode group so as to turn on a high side switch and a low side switch inside the scan ICs using the controller for supplying a signal to each of the electrodes in the plasma display panel.

Still another embodiment of the present invention is achieved by providing a method for driving a plasma display panel, the method comprising the steps of: connecting a plurality of scan electrode groups with a plurality of scan ICs, the scan electrode groups being classified according to specific references in the plasma display panel; setting a plurality of first output control terminal groups for connecting the first output control terminal in the scan ICs which is classified according to the first reference out of the specific references; setting a plurality of second output control terminal groups for connecting the second output control terminal in the scan ICs which is classified according to the second reference out of the specific references; and applying a driving signal to one group out of the scan electrode groups, the driving signal including an intermediate descent period in which a certain voltage is maintained for a predetermined time, and the certain voltage having a lower value than a maximum amplitude of the driving signal and a higher value than a GND voltage during a descent period of the reset period in the driving signal applied to the scan electrode, using the controller for supplying a signal to each of the electrodes in the plasma display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram showing a plasma display panel which is driven in an AC-type three-electrode surface emitting manner;

FIG. 2 is a block diagram showing a driving apparatus of a plasma display panel used in the present invention;

FIG. 3 is a timing view illustrating a driving signal used in the present invention;

FIGS. 4A thru 4D are detailed circuit views showing a Y electrode driver of the plasma display panel used in the present invention, and diagrams showing a flow of electrical current in the Y electrode driver;

FIG. 5 is a diagram showing a pin structure of a scan IC used in the present invention;

FIG. 6 is a truth table showing state values of output terminals according to state values of OC1 and OC2 terminals;

FIG. 7 is a diagram showing that the output control terminals (OC1, OC2) of the scan ICs are connected to each other;

FIG. 8 is a timing view showing a signal applied to the output control terminals (OC1, OC2) during the reset period;

FIG. 9A is a block diagram showing that the connection between the scan IC and the output control terminals (OC1, OC2) is modified according to one embodiment of the present invention;

FIG. 9B is a diagram showing that a timing of the output control terminals (OC1, OC2) is controlled to modify the signal inputted to the Y electrode;

FIG. 10A is a block diagram showing that the connection between the scan IC and the output control terminals (OC1, OC2) is modified according to another embodiment of the present invention;

FIG. 10B is a diagram showing that a timing of the output control terminals (OC1, OC2) is controlled to modify the signal inputted to the Y electrode;

FIG. 11A is a block diagram showing that the connection between the scan IC and the output control terminals (OC1, OC2) is modified according to still another embodiment of the present invention;

FIG. 11B is a diagram showing that a timing of the output control terminals (OC1, OC2) is controlled to modify the signal inputted to the Y electrode;

FIGS. 12A thru 12D are timing tables of an output control terminal for variously modifying a configuration according to the embodiment of FIG. 11;

FIG. 13A is a block diagram showing that the connection between the scan IC and the output control terminals (OC1, OC2) is modified according to yet another embodiment of the present invention;

FIG. 13B is a diagram showing that a timing of the output control terminals (OC1, OC2) is controlled to modify the signal inputted to the Y electrode; and

FIGS. 14A thru 14D are timing tables of an output control terminal for variously modifying a configuration according to the embodiment of FIG. 13.

### DETAILED DESCRIPTION OF THE INVENTION

Hereinafter, preferable embodiments according to the present invention will be described with reference to the accompanying drawings. When one element is connected to another element, one element may be not only directly connected to another element but also indirectly connected to another element via another element. Further, irrelevant elements are omitted for clarity. Also, like reference numerals refer to like elements throughout.

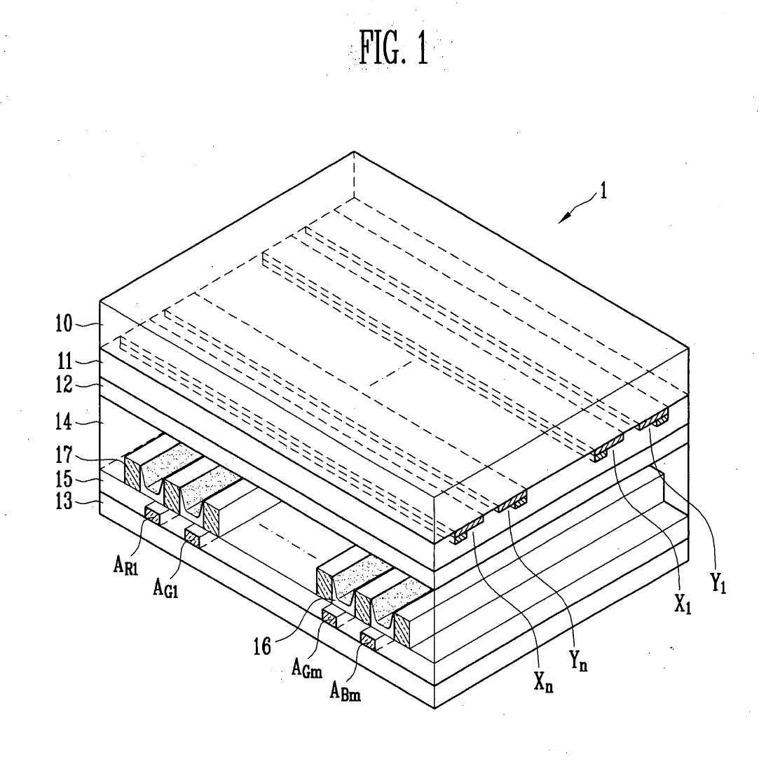

FIG. 1 shows a plasma display panel which is driven in an AC-type three-electrode surface emitting manner.

Referring to FIG. 1, address electrode lines (AR1, AG1, . . . , AGm, ABm), dielectric layers 11, 15, scan electrodes (Y1, . . . Yn) arranged in parallel with the address electrodes while forming a pair with the address electrodes in a vertical direction, sustain (common) electrodes (X1, . . . Xn), and a magnesium monoxide (MgO) layer 12 as a passivation layer are installed between glass substrates 10 and 13 arranged in a front surface and a rear surface of a plasma display panel 1. Also, barrier ribs 17 for dividing the address electrode lines are installed between the glass substrates 10 and 13, and a phosphor 16 is applied to the barrier rib 17 to emit R, G and B visible rays in every line.

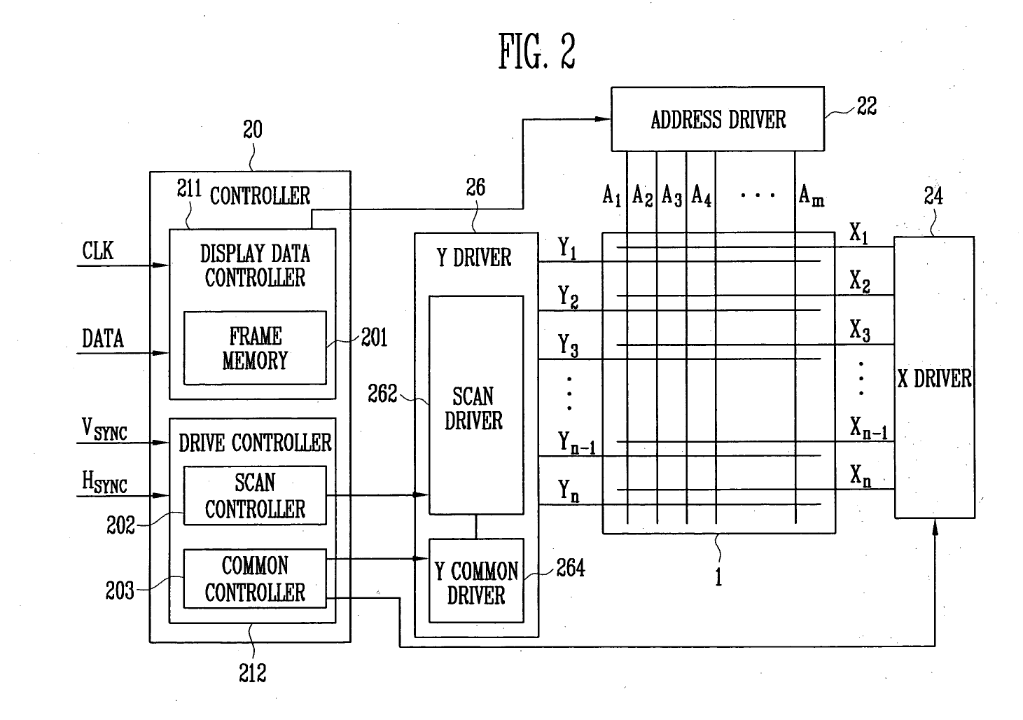

FIG. 2 is a block diagram showing a driving apparatus of a plasma display panel used in the present invention.

Referring to FIG. 2, the driving apparatus includes: a Y driver 26 for driving a plurality of scan electrodes; an X driver 24 for driving a plurality of the sustain electrodes; and an address driver 22 for driving a plurality of the address electrodes. The apparatus further includes: a controller 20 for generating a scan signal, a sustain discharge signal and an address signal so as to transmit the scan signal, the sustain discharge signal and the address signal to each of drivers for the plasma display panel; and a plurality of scan electrodes, a plurality of sustain electrodes and a plurality of address electrodes formed in a direction so as to cross with the scan electrodes and the sustain electrodes.

The controller 20 including a display data controller 211 and a drive controller 212, the display data controller 211 including a frame memory 201, and the drive controller 212 including a scan controller 202 and a common controller 203.

The Y driver 26 includes a scan driver 262 and a Y common driver 264.

The controller 20 receives a clock signal (CLK), a data signal (DATA), a vertical synchronization signal (V_{SYNC}) and a horizontal synchronization signal (H_{SYNC}) from the outside. The display data controller 211 stores the data signal (DATA) in the internal frame memory 201 according to the clock signal (CLK), thereby inputting the corresponding address control signal to the address driver 22.

The drive controller 212 for processing the vertical synchronization signal (V_{SYNC}) and the horizontal synchronization signal (H_{SYNC}) includes a scan controller 202 and a common controller 203. The scan controller 202 generates signals for controlling the scan driver 262, and the common controller 203 generates signals for controlling the Y common driver 264 and the X driver 24. The address driver 22 processes the address control signal from the display data controller 211 to apply the corresponding display data signals to address electrode lines (A1, . . . , Am) of a panel 1 in the address step. The scan driver 262 of the Y driver 26 applies the corresponding scan driving signal to scan electrode lines (Y1, . . . , Yn) according to the control signal from the scan controller 202 in the address step. The Y common driver 264 of the Y driver 26 simultaneously applies the common driving signal to Y electrode lines (Y1, . . . , Yn) according to the control signal from the common controller 212 in the sustain discharge step. The X driver 24 applies the common driving signal to X electrode lines (X1, . . . , Xn) according to the control signal from the common controller 203 in the sustain discharge step.

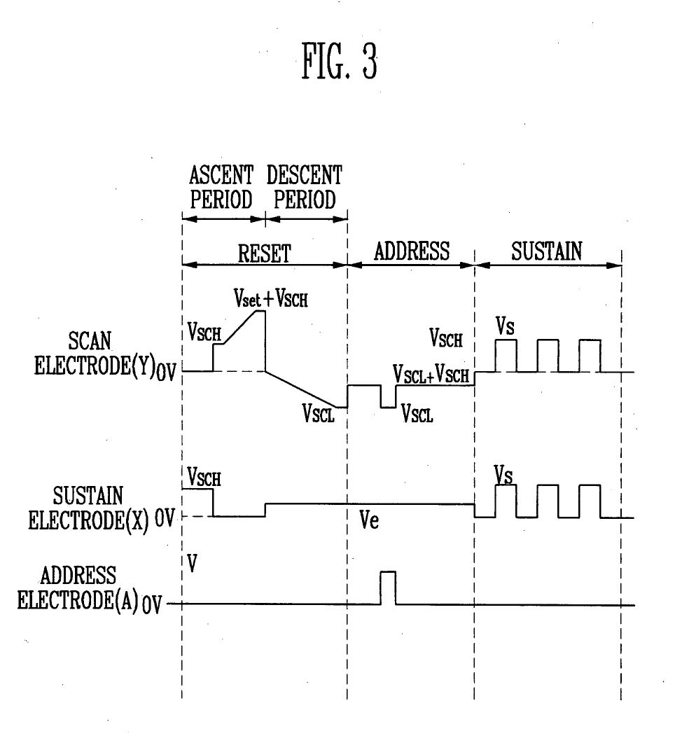

FIG. 3 is a timing diagram illustrating a driving signal used in the present invention. Driving signals applied to an address electrode (A), a common electrode (X) and a scan electrode (Y1˜Yn) are shown in one subfield (SF) in an ADS (Address Display Separation) driving system of an AC PDP in FIG. 3.

Further referring to FIG. 3, one subfield (SF) includes a reset period, an address period and a sustain discharge period.

A voltage of the Y electrode is gradually increased from VscH to as much as Vset, and is increased to Vset+VscH while the A electrode is maintained at a reference voltage during the ascent period of the reset periods. A faint discharge is generated between the Y electrode and the X electrode, and between the Y electrode and the A electrode, as a voltage of the Y electrode is increased, and therefore a (−) wall charge is formed in the Y electrode, and a (+) wall charge is formed in the X and A electrodes. In addition, if the voltage of the electrode is gradually changed, then a wall charge is formed so that the sum of the voltage, applied from the outside, and the wall voltage of the cells can be maintained in the state of a firing voltage while the weak discharge is generated in the cells.

Then, a voltage of the Y electrode descends to a GND voltage, and then to a VscL voltage, while the A electrode is maintained in the reference voltage during the descent period of the reset periods. The (−) wall charge formed in the Y electrode, and the (+) wall charge formed in the X electrode and the A electrode, are erased during a period when the weak discharge is generated between the Y electrode and the X electrode, and between the Y electrode and the A electrode, as the voltage of the Y electrode is decreased.

An address period is carried out after the reset period. At this point, a display cell is selected during the address period by applying a bias voltage to the common electrode (X) and by simultaneously turning on the scan electrodes (Y1˜Yn) and the address electrodes (A1˜Am) in the cells which display an image. For the cells which are turned on during the address period, a scan pulse having a capacity of VscH+VscL is inputted to the scan electrode.

After the address period, the sustain pulse (Vs) is alternately applied to the common electrode (X) and the scan electrode (Y1˜Yn) so as to carry out a sustain discharge period. A low-level voltage (OV) is applied to the address electrodes (A1˜Am) during the sustain discharge period. The luminance of the PDP is adjusted by means of the sustain discharge pulse number. The luminance is increased as the sustain discharge pulse number increases in one subfield or one TV field.

A high voltage of Vset+VscH=315V is applied to the Y electrode right before the descent period of the reset periods is started since the VscH out of the voltage is applied at about 120 V and the Vset is applied at 195 V. Therefore, an internal pressure of the switching elements is increased in the driving circuit, as described above. Particularly, a detailed circuit view of the Y electrode driver will be described so as to describe the switching element having the internal pressure.

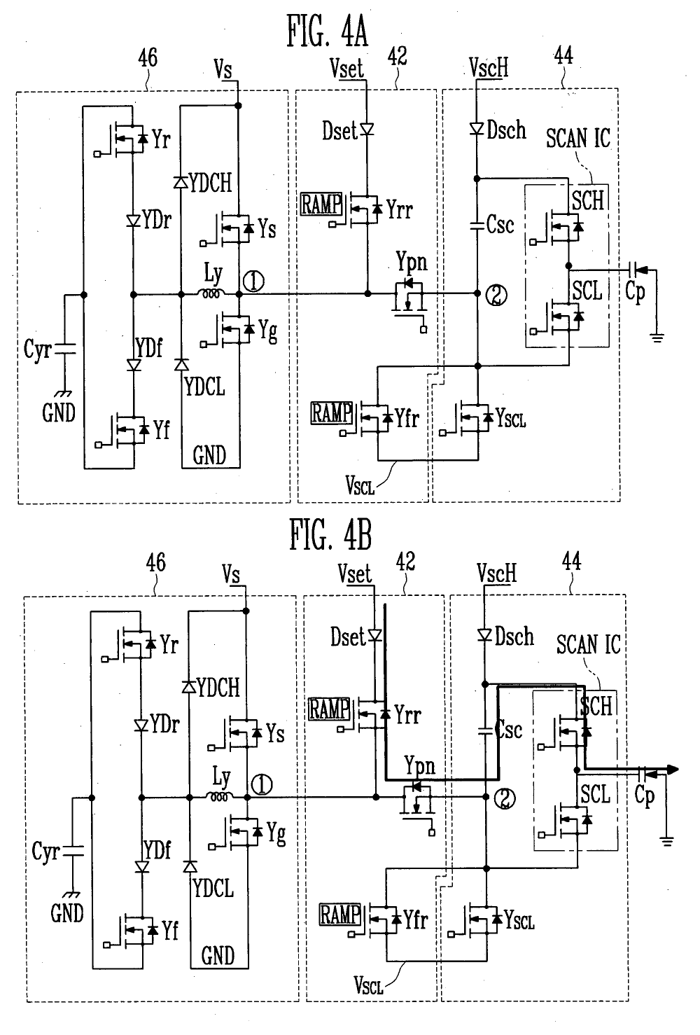

FIG. 4A is a detailed circuit view showing a Y electrode driver of the plasma display panel used in the present invention, and FIGS. 4B to 4D are diagrams showing a flow of electrical current in the Y electrode driver during a reset period.

At first, referring to FIG. 4A, the Y electrode driver includes a reset driver 42, a scan driver 44 and a sustain driver 46.

The reset driver 42 includes: a power source (Vset) for supplying a voltage (Vset); a diode (Dset) for interrupting an electrical current path expanded to diode (Dset)-power source (Vset); and a ramp switch (Yrr) as an ascent ramp unit for generating a reset waveform ascending during the reset period, and also including a ramp switch (Yfr) connected to a power source (VscL); and a switch (Ypn) formed in a main path in which a discharge voltage is applied to the panel capacitor (Cp) so as to prevent an electrical current from flowing backward as a descent ramp unit for generating a descending reset waveform.

The scan driver 44 generates a scan pulse in the address period, and includes power sources (VscH, VscL), a capacitor (Csc), a switch (YscL) and a scan IC. The scan IC, in which a selection circuit is connected in an IC type to each of the Y electrodes (Y1-Yn) so that it can sequentially select a plurality of the Y electrodes (Y1-Yn), includes a high side switch (SCH) and a low side switch (SCL), and a source of the high side switch (SCH) and a drain of the low side switch (SCL) are connected to a Y electrode of the panel capacitor (Cp).

The switch (YscL) is always maintained in a turned-on state during the address period, and the switch (SCL) is turned on in the selected Y electrode and VscL is applied to the selected Y electrode, the sum of the voltage (VscH) is charged in the capacitor (Csc) by the power source (VscH), and the VscL is applied to the unselected Y electrode through the switch (SCH).

The sustain driver 46 generates a sustain discharge pulse during the sustain period, and includes a switch (Ys, Yg) connected between the power source (Vs) and the ground (GND), a power recovery capacitor (Cyr), switches (Yr, Yf), an inductor (Ly), and diodes (YDr, YDf, YDCH, YDCL).

A voltage (Vs/2) is charged in the capacitor (Cyr) before the sustain period, and if the switch (Yr) is turned on during the sustain period, then a panel capacitor (Cp) is charged since a resonance is generated between the inductor (Ly) and the panel capacitor (Cp). Then, the voltage (Vs) is supplied to the panel capacitor (Cp) through the switch (Ys). Also If the switch (Yf) is turned on, then the panel capacitor (Cp) is discharged since a resonance is generated between the inductor (Ly) and the panel capacitor (Cp), and then a voltage of the panel capacitor (Cp) is maintained at a voltage of 0 V through the switch (Yg).

At this point, the diode (YDr, YDf) is formed in an opposite direction to a body diode of the switches (Yr, Yf) so as to interrupt an electrical current which may be formed by the body diode of the switches (Yr, Yf), and the diodes (YDCH, YDCL) clamp second end potentials of the power source (Vs) and the inductor (Ly).

The flow of electrical current during a reset period will now be described with reference to FIGS. 4B thru 4D.

Referring to FIG. 4B, a voltage (VscH) is applied to the Y electrode during an initial reset period (an ascent period in FIG. 3), and then a voltage of the panel capacitor (Cp) gradually ascends to Vset+VscH if the switch (Yrr) is turned on. At this point, a switch (SCH) arranged on a high side of the scan IC is turned on to supply an electrical current.

Referring to FIG. 4C, the switch (Yrr) is turned off during a descent period (a descent period in FIG. 3), and then OV is applied to the Y electrode while switches (Yg, Ypn) and a switch (SCL) arranged on a low side of the scan IC are turned on.

Next, referring to FIG. 4D, the electrode charged in the Y electrode is gradually decreased to a voltage (VscL) if the switch (Yfr) is turned on (a descent period in FIG. 3).

As described above, in this configuration, voltages of 195 V, 120 V and −190V are applied to Vset, VscH and VscL, respectively, and therefore the voltage which a switch element endures, namely, an internal pressure, is high since the sudden change of voltage is caused during the descent period out of the reset periods.

An internal pressure applied to a Yg switch will be described with reference to FIGS. 4B thru 4D. The Yg switch is open right before the descent of a reset voltage, and then a voltage applied to both ends of the Yg switch becomes a voltage of 195 V since the voltage applied to a first node is identical to Vset.

In the case of Yfr, a voltage applied to both ends of the Yfr switch becomes Vset−VscL=195−(−190)=385V since the voltage applied to the second node right before the Yfr switch is turned on is Vset. As described above, the internal pressures of the Yg switch and the Yfr switch are high during the descent period of the reset periods.

Accordingly, the internal pressure applied to each of the switches inside the drive circuit is lowered by diversely dispersing a voltage applied during the descent period of the reset signal out of the driving signal applied to each of the Y electrodes. A method for controlling an output control terminal (OC) of the scan IC is used to disperse the applied time points in the present invention.

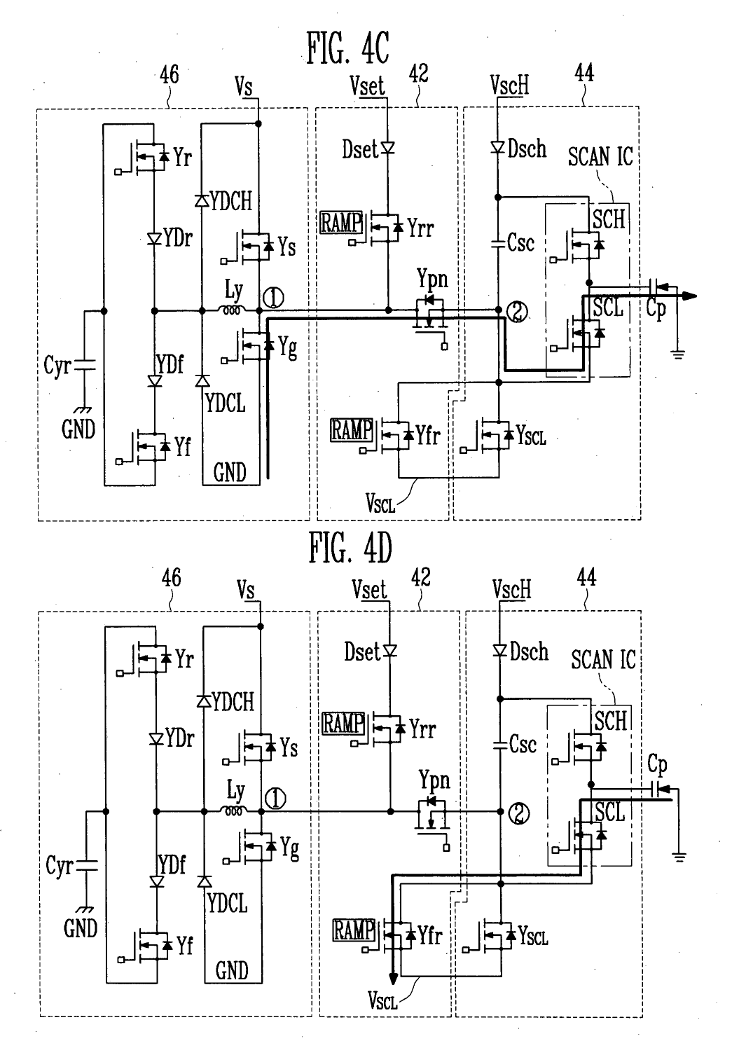

FIG. 5 is a diagram showing a pin structure of the scan IC.

Referring to FIG. 5, the scan IC includes 64 output terminals (HVO1˜HVO64) which may be connected to a total of 64 Y electrode lines, and also includes output control terminals (OC1, OC2) in an upper 90th position.

A 42-inch panel used for the present invention has a total of 768 scan electrode lines, and therefore 12 scan ICs having 64 output terminals are required (64*12=768).

The OC1 and OC2 terminals determine whether the switches (SCH, SCL) in the scan driver 44 of FIG. 4A are turned on or off, depending on their state values, and the state values of the OC1 and OC2 terminals are controlled by the drive controller 212 in the controller 20 of FIG. 2, as described above.

FIG. 6 is a truth table showing state values of output terminals according to state values of OC1 and OC2 terminals.

Referring to FIG. 6, an output terminal (HVO) has a total of three state values according to the state values of the OC1 and OC2 terminals.

First, if the OC1 is H and the OC2 is L, then all output terminals (HVO) are in a GND state, indicating that a low side switch (SCL) is in a turned-on state.

If the OC1 is L and the OC2 is also L, then all output terminals (HVO) are in a high impedance, namely in a floating state, and maintain a previous state value.

If the OC1 is H and the OC2 is also H, then all output terminals (HVO) are in a VH state, indicating that a high side switch (SCH) is in a turned-on state.

If the OC1 is L and the OC2 is H, a previous state value is maintained intact since the state value is not defined.

As described above, an output of the output terminal (HVO) may be changed by changing the state values inputted to the OC1 and OC2 terminals since the output of the output terminal (HVO) is varied according to the state values of the OC1 and OC2 terminals.

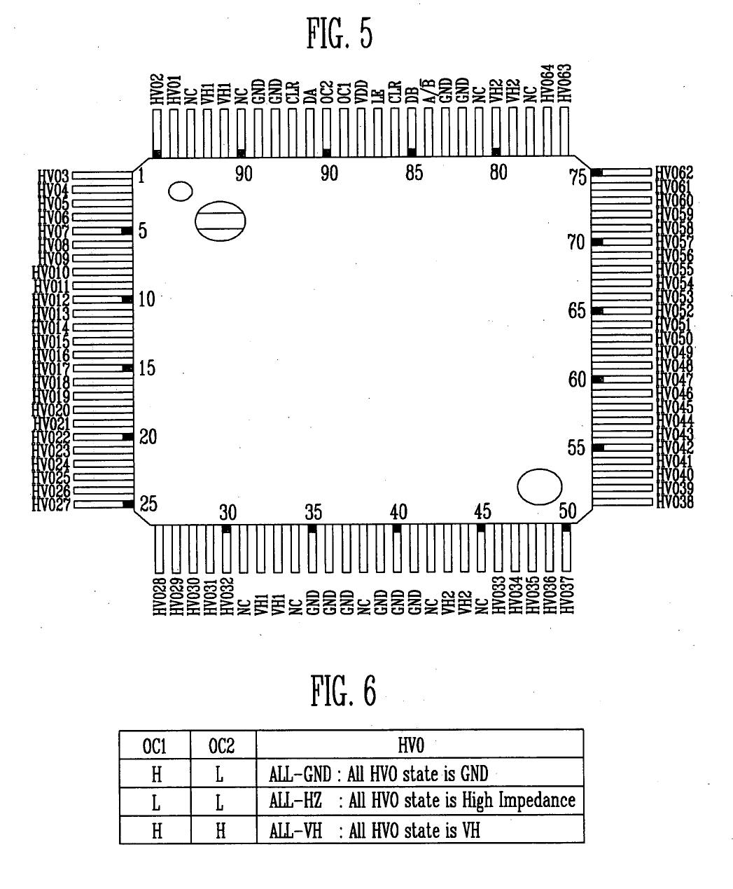

FIG. 7 is a diagram showing that the output control terminals (OC1, OC2) of the scan ICs, used for the present invention are connected to each other.

Referring to FIG. 7, the plasma display panel includes a total of twelve scan ICs, and an OC1 terminal and an OC2 terminal of each of the scan ICs may be connected to each other so as to apply the same signal to each of the scan ICs. That is to say, all scan ICs are equally controlled when a signal is inputted once. The timing signal applied to the OC1 and OC2 terminals will be described in detail.

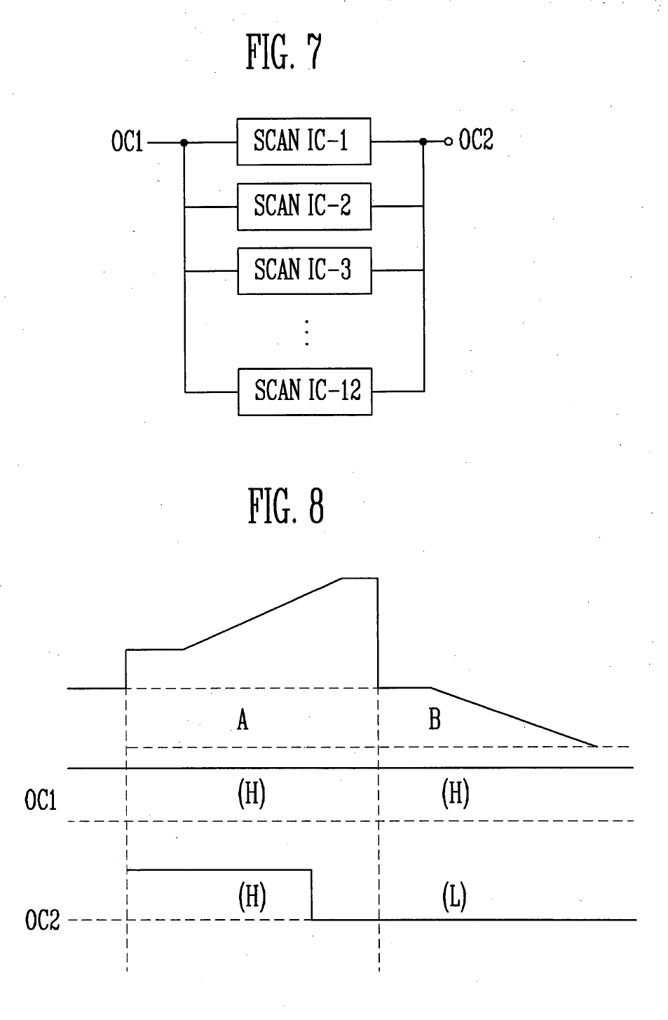

FIG. 8 is a timing diagram showing a signal applied to the output control terminals (OC1, OC2) during the reset period.

Referring to FIG. 4B and FIG. 8, both OC1 and OC2 are at a high level since a high side switch (SCH) of the scan IC is turned on during the ascent period of the reset periods. Moreover, referring to FIGS. 4C and 4D and FIG. 8, OC1 is in a high level and OC2 is in a low level since a low side switch (SCL) of the scan IC is turned on during the ascent period of the reset periods. As described above, the internal pressure applied to the Yg, Yfr switches during the descent period of the reset periods is lowered by variously changing their configurations in every scan electrode group since an output of the output terminal is controlled by the signal applied to the output control terminal.

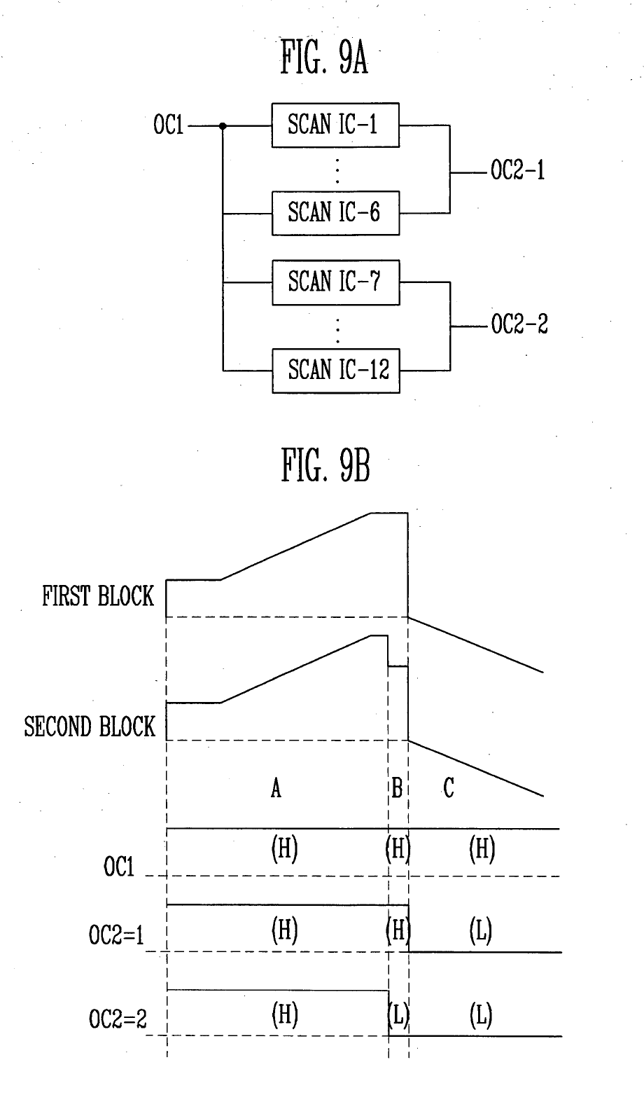

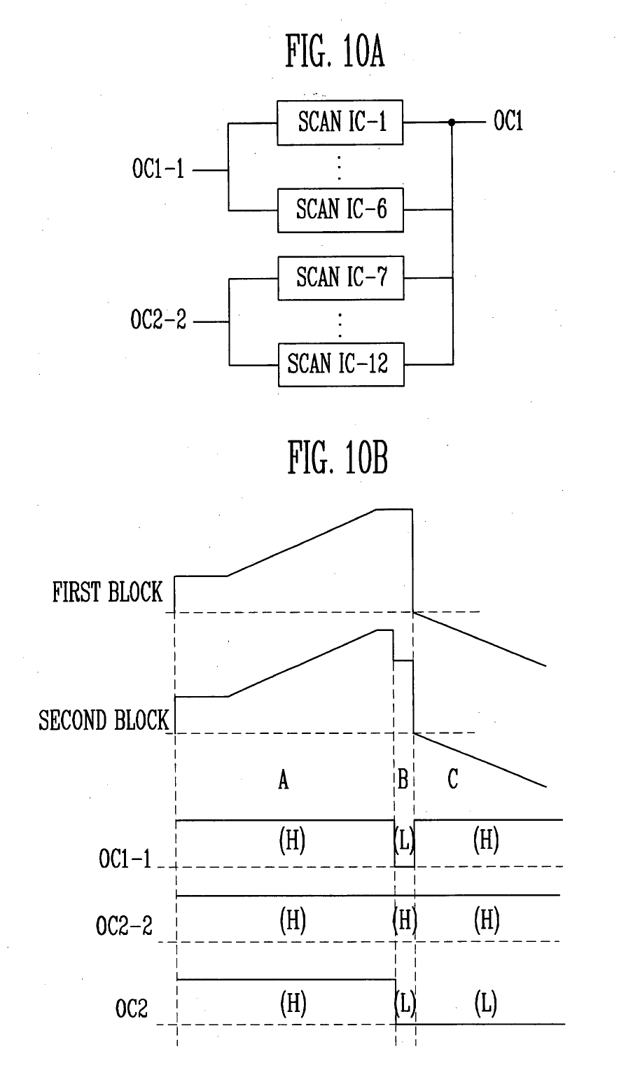

FIG. 9A is a block diagram showing that the connection between the scan IC and the output control terminals (OC1, OC2) is modified according to one embodiment of the present invention, and FIG. 9B is a diagram showing that a timing of the output control terminals (OC1, OC2) is controlled to modify the signal inputted to the Y electrode.

At first, referring to FIG. 9A, each of the scan ICs is connected to a plurality of scan electrode groups in which the scan electrodes are classified according to a specific reference, and a plurality of second output control terminal groups are formed, the second output control terminal groups connecting the second output control terminals of the scan ICs which are classified according to the specific reference.

In this embodiment, the specific reference is based on a hypothetical center line in a horizontal direction relative to all of the plasma display panels, and an upper block of the center line is referred to as a first block while a lower block is referred to as a second block. At this point, in order to leave a difference between reset signals applied to the first block and the second block, OC2 terminals of the scan ICs, connected to the scan electrode line of the first block, are connected to each other, and then this is referred to as an OC2-1 terminal. Also, OC2 terminals of the scan ICs, connected to the Y electrode line of the second block, are connected to each other, and this is referred to as an OC2-2 terminal. However, the same signal is applied to all of the OC1 terminals regardless of the position of the blocks.

In this embodiment, the OC2-1 terminal and the OC2-2 terminal constitute a second output control terminal group, and the OC1 terminal represents the first output control terminal group in an undivided state.

As described above, in this configuration, the OC1 signal is applied to all of the scan ICs at the same voltage level, but the OC2 signal is applied to the first block and the second block at a different voltage level.

Referring to FIG. 9B, the descent period of the reset signal is differently configured in every scan electrode group by applying a high level signal or a low level signal to the first output control terminal groups and a plurality of the second output control terminal groups during a predetermined period out of the descent period of the reset periods of the scan electrode driving signal for at least one scan electrode group to turn on high side switches and low side switches inside the scan ICs.

That is to say, the reset period includes a descent period descending from a maximum amplitude voltage to a GND voltage. At this point, the descent period includes an intermediate descent period in which a certain voltage is maintained for a predetermined time, the certain voltage having a lower voltage than the maximum amplitude voltage and a higher voltage than the GND voltage, and a driving signal including the intermediate descent period is applied to at least one scan electrode group.

The OC1 and OC2 terminals apply a high level signal to turn on high side switches (SCH) of the scan IC during the A period.

A difference is left between signals applied to the first block and the second block during the B period, and then both of the OC1 and OC2-1 terminals apply a high level signal to turn on the high side switch (SCH) of the scan IC so that the signal applied to the first block can be identical to the previous signal, and the OC1 terminal applies a high level signal and the OC2-2 terminal applies a low level signal to turn on the low side switch (SCL) of the scan IC so that the signal applied to the second block can be a signal having a rather decreased voltage. That is to say, the driving signal including the above-mentioned intermediate descent period is applied during the B period, and the driving signal including the intermediate descent period is applied to the scan electrode group connected to the second block in this embodiment.

The OC1 terminal applies a high level signal during the C period, and both of the OC1 and OC2 terminals apply a low level signal to turn on the low side switch (SCL) of the scan IC.

At this point, referring to FIG. 4, in order to determine the extent to which a voltage of a signal applied to the second block descends, the low side switch (SCL) is turned on, and therefore only a Vset voltage is applied since a VscH voltage source is not connected. That is to say, the voltage in the first block is suddenly decreased, but the internal pressure of the switch is lowered since the Vset voltage is applied once again during the intermediate descent period when the voltage is decreased in the second block.

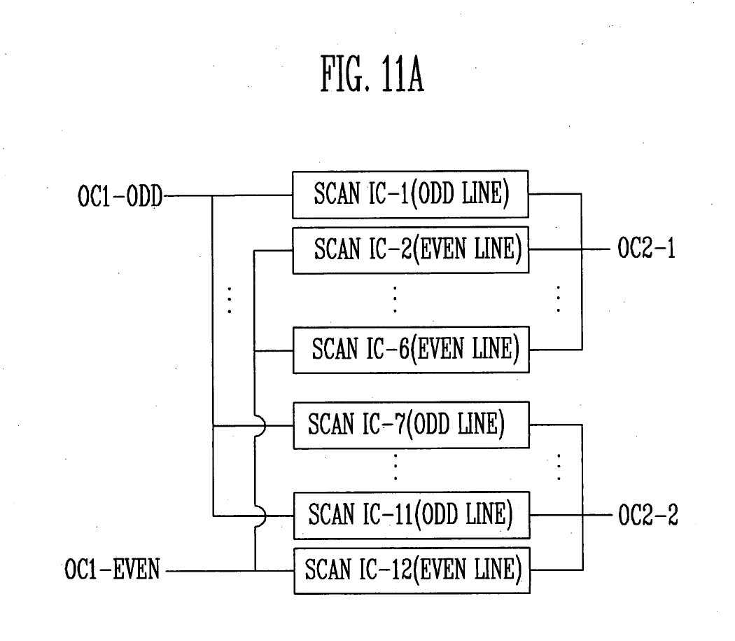

Meanwhile, the configuration as described above may be modified to apply the same signal to the OC2 terminal, and to have an OC1 signal applied to the first block and the second block, as shown in FIGS. 10A and 10B.

FIG. 10A is a block diagram showing that the connection between the scan IC and the output control terminals (OC1, OC2) is modified according to another embodiment of the present invention, and FIG. 10B is a diagram showing that a timing of the output control terminals (OC1, OC2) is controlled to modify the signal inputted to the Y electrode.

Referring to FIG. 10A, each of the scan ICs is connected to a plurality of scan electrode groups in which the scan electrodes are classified according to a specific reference, and, unlike FIG. 9A, a plurality of first output control terminal groups is formed, the first output control terminal groups connecting the first output control terminals of the scan ICs which are classified according to the specific reference.

In this embodiment, the specific reference is based on a hypothetical center line in a horizontal direction relative to all of the plasma display panels, and an upper block of the center line is referred to as a first block, and a lower block is referred to as a second block. At this point, in order to leave a difference between reset signals applied to the first block and the second block, OC1 terminals of the scan ICs, connected to the scan electrode line of the first block, are connected to each other, and this is referred to as an OC1-1 terminal. Also, OC1 terminals of the scan ICs, connected to the Y electrode line of the second block, are connected to each other, and this is referred to as OC1-2 terminal. However, the same signal is applied to all of the OC2 terminals regardless of the position of the blocks.

In this embodiment, the first output control terminal group is divided into an OC1-1 terminal and an OC1-2 terminal, and the second output control terminal group is represented by an OC2 terminal.

As described above, in this configuration, the OC2 signal is applied to all of the scan ICs at the same voltage level, but the OC1 signal is applied to the first block and the second block at a different voltage level.

Referring to FIG. 10B, the descent period of the reset signal is differently configured in every scan electrode group by applying a high level signal or a low level signal to a plurality of the first output control terminal groups and the single second output control terminal group during a predetermined period out of the descent period of the reset periods of the scan electrode driving signal so that at least one scan electrode groups to turn on high side switches and low side switches inside the scan ICs.

That is to say, the reset period includes a descent period descending from a maximum amplitude voltage to a GND voltage. At this point, the descent period includes an intermediate descent period in which a certain voltage is maintained for a predetermined time, the certain voltage having a lower voltage than the maximum amplitude voltage and a higher voltage than the GND voltage, and a driving signal including the intermediate descent period is applied to at least one scan electrode group.

The detailed description is identical to the context as described in FIG. 9B except that the signal applied to the OC1-1 terminal is substantially different from the signal applied to the OC1-2 terminal, and therefore their descriptions are omitted.

Meanwhile, a method in which different reset signals are applied by classifying scan electrode lines into odd-numbered electrode lines and even-numbered electrode lines may also be considered, except for the method for applying different reset signals to the first block and the second block as described above.

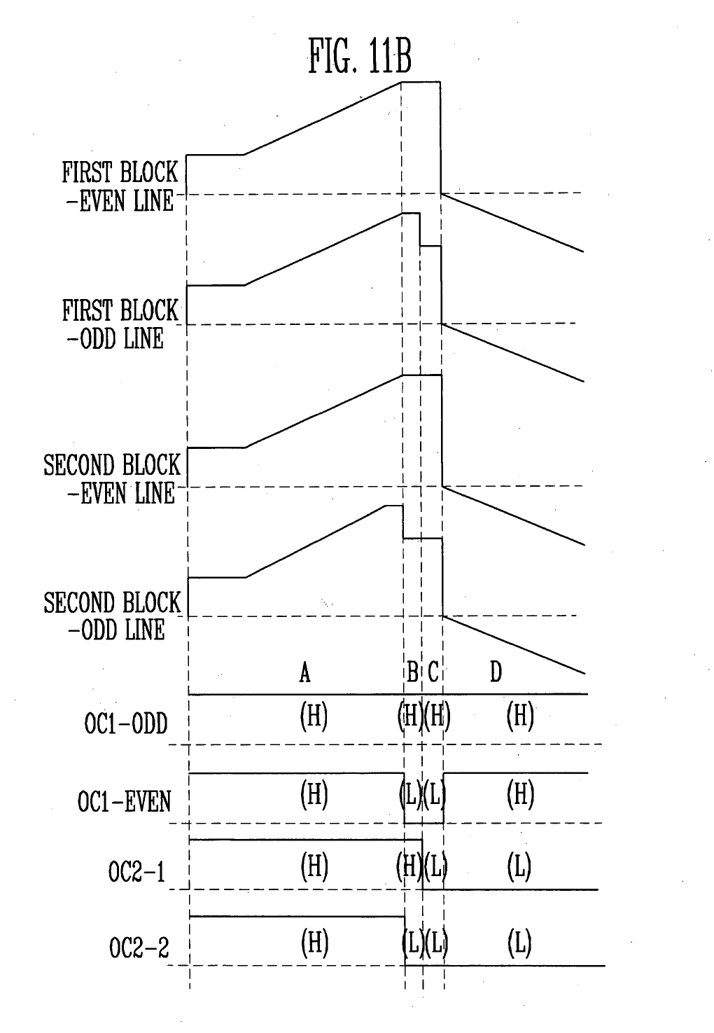

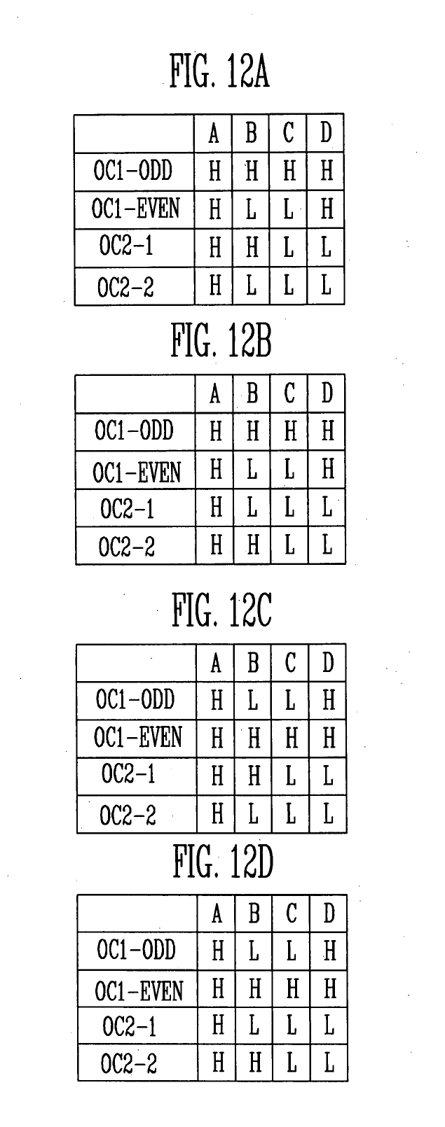

FIG. 11A is a block diagram showing that the connection between the scan IC and the output control terminals (OC1, OC2) is modified according to still another embodiment of the present invention, and FIG. 11B is a diagram showing that a timing of the output control terminals (OC1, OC2) is controlled so as to modify the signal inputted to the Y electrode.

First, referring to FIG. 11A, each of the scan ICs is connected to plurality of scan electrode groups in which the scan electrodes are classified according to a specific reference, and then a plurality of first output control terminal groups and a plurality of second output control terminal groups are formed, the first output control terminal groups connecting the first output control terminals of the scan ICs which are classified according to a first reference of the specific references, and the second output control terminal groups connecting the second output control terminals of the scan ICs which are classified according to a second reference of the specific references.

In this embodiment, the specific reference is referred to as a first reference so as to determine whether or not it is an odd-numbered line out of the scan electrode lines of the plasma display panel, and the specific reference is referred to as a second reference so as to determine whether or not it is an upper block on the basis of a hypothetical center line in a horizontal direction to the entire plasma display panels.

OC1 terminals of the scan ICs, connected to only odd-numbered lines of the scan electrode line along the first reference, are connected to each other, and these are referred to as OC1-odd-numbered terminals. Also, OC1 terminals of the scan ICs, connected to only even-numbered lines of the scan electrode line along the first reference, are connected to each other, and these are referred to as OC1-even-numbered terminals.

Also, an upper block of the center line is referred to as a first block, and a lower block thereof is referred to as a second block, based on the second reference. At this point, in order to leave a difference between reset signals applied to the first block and the second block, OC2 terminals of the scan ICs, connected to the scan electrode line of the first block, are connected to each other, and they are referred to as OC2-1 terminals. Also, OC2 terminals of the scan ICs, connected to the scan electrode line of the second block, are connected to each other, and they are referred to as OC2-2 terminals.

That is to say, the first output control terminal group is divided into an OC1-even-numbered terminal and an OC1-odd-numbered terminal along the first reference, and the second output control terminal group is divided into an OC2-1 terminal and an OC2-2 terminal along the second reference.

As described above, in this configuration, the reset signal is inputted in more varied ways than in the embodiments shown in FIGS. 9 and 10 since the OC1 signals applied to the odd-numbered lines and the even-numbered lines, as well as the OC2 signals applied to the first block and the second block, are applied in different ways.

However, the odd-numbered lines and the even-numbered lines should be separately inputted to every scan IC for the purpose of the combination of the scan ICs and the Y electrode lines in the above-mentioned configuration.

Referring to FIG. 11B, the descent period of the reset signal is differently configured in every scan electrode group by applying a high level signal or a low level signal to a plurality of the first output control terminal groups and a plurality of the single second output control terminal groups during a predetermined period out of the descent period of the reset periods of the scan electrode driving signal so that at least one scan electrode group turns on high side switches and low side switches inside the scan ICs.

That is to say, the reset period includes a descent period descending from a maximum amplitude voltage to a GND voltage. At this point, the descent period includes an intermediate descent period in which a certain voltage is maintained for a predetermined time, the certain voltage having a lower voltage than the maximum amplitude voltage and a higher voltage than the GND voltage, and a driving signal including the intermediate descent period is applied to at least one scan electrode group.

The signals applied to the OC2-1 terminal and the OC2-2 terminal, and the signals applied to the OC1-odd-numbered terminal and the OC1-even-numbered terminal, are set to different voltage values, and therefore the descent period of the reset signals applied to the first block-even-numbered lines, the first block-odd-numbered lines, the second block-even-numbered lines and the second block-odd-numbered lines are differently configured. However, unlike the embodiment described above, the scan electrode groups to which the driving signal, including the intermediate descent period, is applied are two groups, and time points when the intermediate descent period is applied to the scan electrode groups are differently configured.

The OC1 and OC2 terminals apply a high level signal to turn on high side switches (SCH) of the scan IC during the A period.

The final state values are maintained regardless of the signal values of the OC2-1 and the OC2-2 by applying a low level signal to the OC1-even-numbered terminals so that the signals applied to the even-numbered lines during the B period can be identical to the previous reset signal. Referring to FIG. 6 described above, if the OC1 is at a low level, then linear state values are maintained regardless of values of the OC2 signal. All of the OC1-odd-numbered terminals and the OC2-1 terminals apply a high level signal so that the signals applied to the first block-odd-numbered lines can be identical to the previous reset signal.

Meanwhile, the OC2-2 terminals apply a low level signal and the OC1-odd-numbered terminals apply a high level signal to turn on the low side switches (SCL) of the scan ICs so that the signals applied to the second block-odd-numbered lines can be applied with a signal having a rather decreased voltage. At this point, the extent to which the voltage of the signals applied to the second block-odd-numbered lines descends is identical to that in the previous embodiments. That is to say, the driving signal including the above-mentioned intermediate descent period is applied during the B period, and the driving signal including the intermediate descent period is applied to the scan electrode groups connected to the second block-odd-numbered lines in this embodiment.

B period values are maintained regardless of the signal values of the OC2-1 and the OC2-2 by applying a low level signal to the OC1-even-numbered terminals so that the signals applied to the even-numbered lines during the C period can be identical to the previous reset signal. The signals applied to the second block-odd-numbered lines apply the same signal as in the B period in order to turn on the low side switches (SCL) so that the previous B period value can be maintained.

Meanwhile, the OC2-1 terminals apply a low level signal and the OC1-odd-numbered terminals apply a high level signal so as to turn on the low side switches (SCL) of the scan ICs so that the signals applied to the first block-odd-numbered lines can be applied with a signal having a rather decreased voltage. At this point, the extent to which the voltage of the signals applied to the first block-odd-numbered lines descends is identical. That is to say, the driving signal including the above-mentioned intermediate descent period is applied during the C period, and the driving signal including the intermediate descent period is applied to the scan electrode groups connected to the first block-odd-numbered lines in this embodiment.

All OC1 terminals apply a high level signal during the D period, and all OC2 terminals apply a low level signal so as to turn on the low side switches (SCL) of the scan IC.

In total, the signals applied to the OC1 terminal and the OC2 terminal are differently configured so that descending time points of the signals, applied to the first block-odd-numbered lines and the second block-odd-numbered lines, can be different with respect to each other by further dividing the descent period of the reset periods.

Unlike the embodiment of FIG. 11B, this embodiment may be configured so that the signals applied to the first block-odd-numbered lines can descend first and the signals applied to the second block-odd-numbered lines can descend, or it may be configured so that the signals applied to the even-numbered lines, rather than the odd-numbered lines, can descend first.

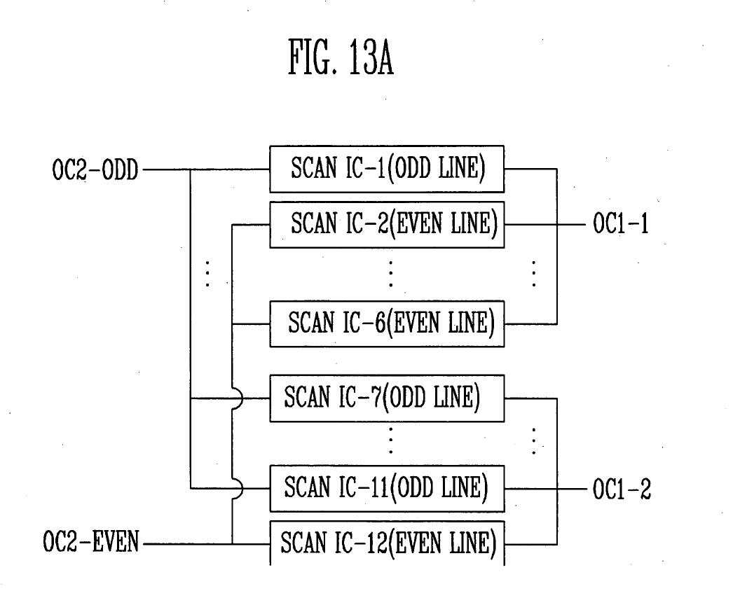

FIGS. 12A thru 12D are timing tables of an output control terminal for variously modifying a configuration according to the embodiment of FIG. 11.

FIG. 12A summarizes the configuration of FIG. 11 in the table. The voltages applied to the OC1-odd-numbered terminal, the OC1-even-numbered terminal, the OC2-1 terminal and the OC2-2 terminal are represented by respective periods (A,B,C,D), H represents a high level signal, and L represents a low level signal.

Unlike the configuration of FIG. 11, FIG. 12B is a timing table showing that first block-odd-numbered lines descend first during the B period, and then second block-odd-numbered lines descend during the C period, and FIGS. 12C and 12D are timing tables showing that signals applied to the even-numbered lines descend first during the B period, unlike the configuration of FIG. 11.

In FIG. 12C, the signals, applied to the first block-odd-numbered lines and the second block-odd-numbered lines, are applied with the same voltage level as the previous reset signal, and this embodiment is configured so that the second block-even-numbered lines descend first during the B period, and then the first block-even-numbered lines descend during the C period.

In FIG. 12D, the signals applied to the first block-odd-numbered lines and the second block-odd-numbered lines are applied with the same voltage level as the previous reset signal, and this embodiment is configured so that the second block-even-numbered lines descend first during the B period, and then the first block-even-numbered lines descend during the C period, as shown in FIG. 12C.

Meanwhile, unlike the embodiment of FIG. 11, the OC1 terminals maybe divided into every scan IC which is connected to the electrode lines applied to the first block and the second block, and then this embodiment may be configured so that the OC2 terminals can be divided into every scan IC which is connected to the odd-numbered lines and the even-numbered lines.

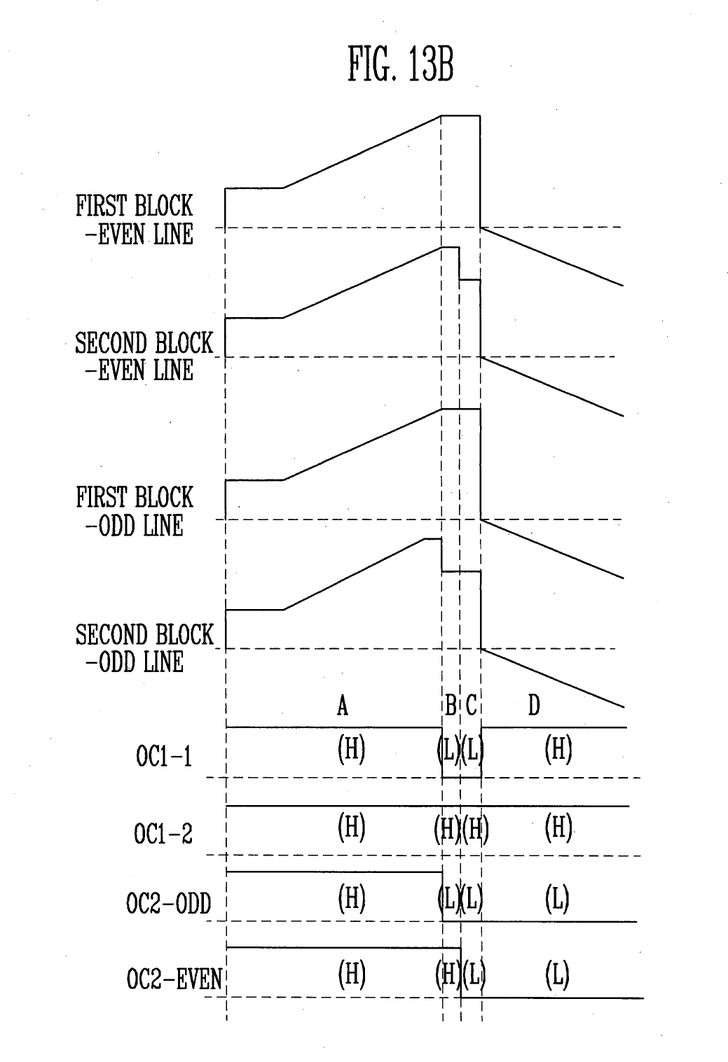

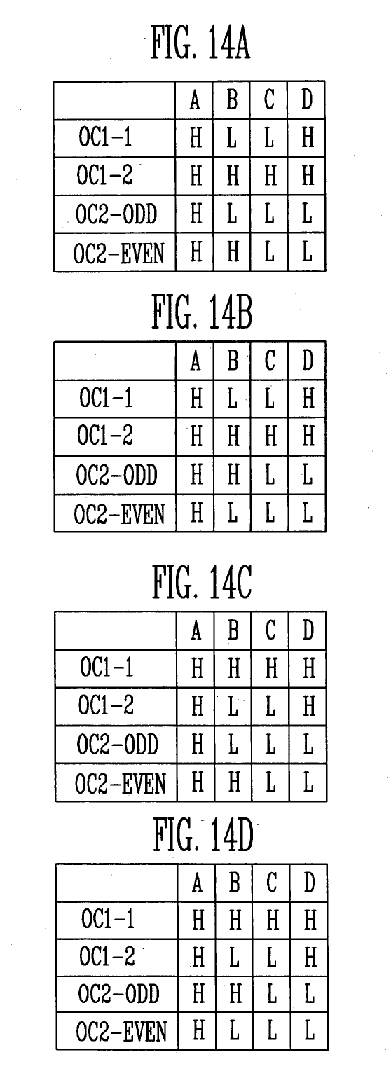

FIG. 13A is a block diagram showing that the connection between the scan IC and the output control terminals (OC1, OC2) is modified according to yet another embodiment of the present invention, and FIG. 13B is a diagram showing that a timing of the output control terminals (OC1, OC2) is controlled so as to modify the signal inputted to the Y electrode.

First, referring to FIG. 13A, the descent period of the reset signal is differently configured in every scan electrode group by applying a high level signal or a low level signal to a plurality of the first output control terminal groups and a plurality of the single second output control terminal groups during a predetermined period out of the descent period of the reset periods of the scan electrode driving signal for at least one scan electrode groups so as to turn on high side switches and low side switches inside the scan ICs.

In this embodiment, the specific reference is referred to as a first reference to determine whether or not it is an upper block on the basis of a hypothetical center line in a horizontal direction relative to the entire plasma display panel, and the specific reference is referred to as a second reference to determine whether or not it is an odd-numbered line out of the scan electrode lines of the plasma display panel

An upper block of the center line is referred to as a first block, and a lower block is referred to as a second block, based on the first reference. At this point, in order to maintain a difference between reset signals applied to the first block and the second block, OC1 terminals of the scan ICs connected to the scan electrode line of the first block are connected to each other, and they are referred to as OC1-1 terminals. Also, OC1 terminals of the scan ICs connected to the Y electrode line of the second block are connected to each other, and they are referred to as OC1-2 terminals.

In addition, OC2 terminals of the scan ICs connected to only odd-numbered lines of the scan electrode line along the second reference are connected to each other, and they are referred to as OC2-odd-numbered terminals. Moreover, OC2 terminals of the scan ICs connected to only even-numbered lines of the scan electrode line along the second reference are connected to each other, and they are referred to as OC2-even-numbered terminals.

That is to say, the first output control terminal group is divided into an OC1-even-numbered terminal and an OC1-odd-numbered terminal along the first reference, and the second output control terminal group is divided into an OC2-1 terminal and an OC2-2 terminal along the second reference.

Referring to FIG. 13B, the signals applied to the OC1-1 terminal and the OC1-2 terminal, and the signals applied to the OC2-odd-numbered terminal and the OC2-even-numbered terminal, are set to different voltage values, and therefore the descent period of the reset signals applied to the first block-even-numbered lines, the first block-odd-numbered lines, the second block-even-numbered lines and the second block-odd-numbered lines are differently configured.

The OC1 and OC2 terminals apply a high level signal to turn on high side switches (SCH) of the scan IC during the A period.

The final state values are maintained during the A period regardless of the signal values of the OC2-odd-numbered and OC2-even-numbered terminals by applying a low level signal to the OC1-1 terminal so that the signals applied to the first block during the B period can be identical to the previous reset signal. All of the OC1-2 terminals and the OC2-even-numbered terminals apply a high level signal so that the signals applied to the second block-even-numbered lines can be identical to the previous reset signal.

Meanwhile, the OC1-2 terminals apply a high level signal and the OC2-odd-numbered terminals apply a low level signal so as to turn on the low side switches (SCL) of the scan ICs so that the signals applied to the second block-odd-numbered lines can be applied with a signal having a rather decreased voltage. At this point, the extent to which the voltage of the signals applied to the second block-odd-numbered lines descends is identical to that of the previous embodiments. That is to say, the driving signal including the above-mentioned intermediate descent period is applied during the B period, and the driving signal including the intermediate descent period is applied to the scan electrode groups connected to the second block-odd-numbered lines in this embodiment.

B period values are maintained regardless of the signal values of the OC2-even-numbered and OC2-odd-numbered terminals by applying a low level signal to the OC1-1 terminals so that the signals applied to the first blocks during the C period can be identical to the previous reset signal. The signals applied to the second block-odd-numbered lines are the same as in the B period in order to turn on the low side switches (SCL) so that it can maintain the previous B period value.

Meanwhile, the OC1-2 terminals apply a low level signal and the OC3-odd-numbered terminals apply a high level signal to turn on the low side switches (SCL) of the scan ICs so that the signals applied to the second block-odd-numbered lines can be signals having a rather decreased voltage. At this point, the extent to which the voltage of the signals applied to the second block-odd-numbered lines descends is identical. That is to say, the driving signal including the above-mentioned intermediate descent period is applied during the C period, and the driving signal including the intermediate descent period is applied to the scan electrode groups connected to the first block-odd-numbered lines in this embodiment.

All OC1 terminals apply a high level signal during the D period, and all OC2 terminals apply a low level signal to turn on the low side switches (SCL) of the scan IC.

In total, the signals applied to the OC1 terminal and the OC2 terminal are differently configured so that descending time points of the signals, applied to the first block-odd-numbered lines and the second block-odd-numbered lines, can be different relative to each other by further dividing the descent period of the reset periods.

Unlike the embodiment of FIG. 13B, this embodiment may be configured so that the signals applied to the second block-even-numbered lines can descend first and the signals applied to the second block-odd-numbered lines can descend, or this embodiment may be configured so that the signals applied to the first blocks, rather than the second blocks, can descend first.

FIGS. 14A thru 14D are timing tables of an output control terminal for variously modifying the configuration according to the embodiment of FIG. 13.

FIG. 14A summarizes the configuration of FIG. 13 in a table. The voltage applied to the OC1-1 terminal, the OC1-2 terminal, the OC2-odd-numbered terminal and the OC2-even-numbered terminal are represented by respective periods (A,B,C,D), H represents a high level signal, and L represents a low level signal.

Unlike the configuration of FIG. 13, FIG. 14B is a timing table showing that the signals applied to the second block-odd-numbered lines descend first during the B period, and then the signals applied to the second block-odd-numbered lines descend during the C period. FIG. 14C and 14D are timing tables showing that the signals applied to the first blocks descend first during the B period, unlike in the configuration of FIG. 13.

In FIG. 14C, the signals applied to the second block-odd-numbered lines and the second block-odd-numbered lines are applied with the same voltage level as the previous reset signal, and this embodiment is configured so that the signals applied to the first block-even-numbered lines descend first during the B period, and then the signals applied to the first block-even-numbered lines descend during the C period.

In FIG. 14D, the signals applied to the second block-odd-numbered lines and the second block-odd-numbered lines are applied with the same voltage level as the previous reset signal, and this embodiment is configured so that the signals applied to the first block-even-numbered lines descend first during the B period, and then the signals applied to the first block-even-numbered lines descend during the C period, as shown in FIG. 14C.

As described above, the internal pressure applied to the switching elements in the drive circuit may be lowered by dividing a scan electrode of the plasma display panel into a plurality of groups on the basis of the specific reference, and leaving a difference of descending voltage in every group during some period when a voltage is suddenly changed for a short time out of the descent period of the reset periods in the driving signal. The expense required for the elements may be lowered with a decrease in the internal pressure applied to the switching elements, and EMI (electromagnetic interference) may be also reduced.

The description proposed herein is merely a preferable example provided for the purpose of illustration only, and it is not intended to limit the scope of the invention. Thus, it should be understood that other equivalents and modifications, as will be apparent to those skilled in the art, can be made thereto without departing from the spirit and scope of the invention. Therefore, it should be understood that the present invention is not limited to the scope of that which is described in the detailed description presented above, but the present invention is limited only the appended claims and their equivalents.

What is claimed is:

1. An apparatus for driving a plasma display panel, comprising:
a plasma display panel including a plurality of scan electrodes, a plurality of sustain electrodes, and a plurality of address electrodes formed in a direction so as to cross the scan electrodes and the sustain electrodes;
a plurality of scan ICs connected to each of a plurality of scan electrode groups into which the scan electrodes are classified according to specific references, said scan ICs controlling whether or not a driving signal is applied by means of first and second output control terminals;
a plurality of first output control terminal groups for connecting a first output control terminal which is classified according to a first reference out of the specific references;
a plurality of second output control terminal groups for connecting a second output control terminal which is classified according to a second reference out of the specific references; and
a controller for applying one of a high level signal and a low level signal to the plurality of the first output control terminal groups and the plurality of the second output control terminal groups during a predetermined period out of a descent period of reset periods of a scan electrode driving signal for at least one scan electrode group so as to turn on high side switches and low side switches inside the scan ICs.

2. The apparatus according to claim 1, wherein the plurality of the scan ICs are connected to one scan electrode group selected from a group comprising:
a first scan electrode group connected to odd-numbered scan electrode lines out of upper panel blocks on a basis of a horizontal direction center line of the plasma display panel;
a second scan electrode group connected to even-numbered scan electrode lines out of the upper panel blocks;
a third scan electrode group connected to odd-numbered scan electrode lines out of lower panel blocks on a basis of the horizontal direction center line; and
a fourth scan electrode group connected to even-numbered scan electrode lines out of the lower panel blocks.

3. The apparatus according to claim 1, wherein each first output control terminal group comprises:
an output control terminal group A for connecting first output control terminals in the scan ICs connected to odd-numbered scan electrode lines of the plasma display panel; and
an output control terminal group B for connecting first output control terminals in the scan ICs connected to even-numbered scan electrode lines of the plasma display panel; and
wherein each second output control terminal group comprises:
an output control terminal group C for connecting second output control terminals in the scan ICs connected to the scan electrode lines for connecting upper panel blocks on a basis of a horizontal direction center line of the plasma display panel; and
an output control terminal group D for connecting second output control terminals in the scan ICs connected to the scan electrode lines for connecting lower panel blocks on the basis of the horizontal direction center line.

4. The apparatus according to claim 1, wherein each first output control terminal group comprises:
an output control terminal group A for connecting first output control terminals in the scan ICs connected to the scan electrode lines for connecting upper panel blocks on a basis of a horizontal direction center line of the plasma display panel; and
an output control terminal group B for connecting first output control terminals in the scan ICs connected to the scan electrode lines for connecting lower panel blocks on the basis of the horizontal direction center line; and
wherein each second output control terminal group comprises:
an output control terminal group C for connecting second output control terminals in the scan ICs connected to odd-numbered scan electrode lines of the plasma display panel; and
an output control terminal group D for connecting second output control terminals in the scan ICs connected to even-numbered scan electrode lines of the plasma display panel.

5. A method for driving a plasma display panel, comprising the steps of:
connecting a plurality of scan electrode groups to a plurality of scan ICs, the scan electrode groups being classified according to specific references in the plasma display panel;
setting a plurality of first output control terminal groups for connecting a first output control terminal in the scan ICs which is classified according to a first reference out of the specific references;
setting a plurality of second output control terminal groups for connecting a second output control terminal in the scan ICs which is classified according to a second reference out of the specific references; and
applying one of a high level signal and a low level signal to the plurality of the first output control terminal groups and the plurality of the second output control terminal groups during a predetermined period out of a descent period of reset periods of a scan electrode driving signal for at least one scan electrode groups so as to turn on a high side switch and a low side switch inside the scan ICs using a controller for supplying a signal to each of electrodes in the plasma display panel.

6. The method according to claim 5, wherein the step of connecting the plurality of scan electrode groups to the plurality of scan ICs comprises connecting the plurality of scan ICs to one scan electrode group selected from the group consisting of:
a first scan electrode group connected to odd-numbered scan electrode lines out of upper panel blocks on a basis of a horizontal direction center line of the plasma display panel;
a second scan electrode group connected to even-numbered scan electrode lines out of the upper panel blocks;
a third scan electrode group connected to odd-numbered scan electrode lines out of lower panel blocks on the basis of the horizontal direction center line; and
a fourth scan electrode group connected to even-numbered scan electrode lines out of the lower panel blocks.

7. The method according to claim 5, wherein the step of setting the plurality of first output control terminal groups comprises:
connecting first output control terminals in the scan ICs connected to odd-numbered scan electrode lines of the plasma display panel so as to set the first output control terminals to an output control terminal group A; and
connecting first output control terminals in the scan ICs connected to even-numbered scan electrode lines of the plasma display panel so as to set the first output control terminals to an output control terminal group B; and
wherein the step of setting the plurality of second output control terminal groups comprises:
connecting second output control terminals in the scan ICs connected to the scan electrode lines for connecting upper panel blocks on a basis of a horizontal direction center line of the plasma display panel so as to set the second output control terminals to an output control terminal group C; and
connecting second output control terminals in the scan ICs connected to the scan electrode lines for connecting lower panel blocks on the basis of the horizontal direction center line so as to set the second output control terminals to an output control terminal group D.

8. The method according to claim 5, wherein the step of setting the plurality of first output control terminal groups comprises:
connecting first output control terminals in the scan ICs connected to scan electrode lines for connecting upper panel blocks on a basis of a horizontal direction center line of the plasma display panel so as to set the first output control terminals to an output control terminal group A; and
connecting first output control terminals in the scan ICs connected to the scan electrode lines for connecting lower panel blocks on the basis of the horizontal direction center line so as to set the first output control terminals to an output control terminal group B; and
wherein the step of setting the plurality of second output control terminal groups comprises:
connecting second output control terminals in the scan ICs connected to odd-numbered scan electrode lines of the plasma display panel so as to set the second output control terminals to an output control terminal group C; and
connecting second output control terminals in the scan ICs connected to even-numbered scan electrode lines of the plasma display panel so as to set the second output control terminals to an output control terminal group B.

9. The method according to claim 5, wherein the controller applies the high level signal to one group out of the first output control terminal groups during the predetermined period, and applies the low level signal to another group out of the second output control terminal groups so as to turn on low side switches inside the scan ICs.

10. A method for driving a plasma display panel, comprising the steps of:
connecting a plurality of scan electrode groups to a plurality of scan ICs, the scan electrode groups being classified according to specific references in the plasma display panel;
setting a plurality of first output control terminal groups for connecting a first output control terminal in the scan ICs which is classified according to a first reference out of the specific references;
setting a plurality of second output control terminal groups for connecting a second output control terminal in the scan ICs which is classified according to a second reference out of the specific references; and
applying a driving signal to one group out of the scan electrode groups, the driving signal including an intermediate descent period in which a certain voltage is maintained for a predetermined time, and the certain voltage having a lower value than a maximum amplitude of the driving signal and a higher value than a GND voltage during a descent period of a reset period in the driving signal applied to a scan electrode using a controller for supplying a signal to each electrode in the plasma display panel.

11. The method according to claim 10, wherein the step of connecting the plurality of scan electrode groups to the plurality of scan ICs comprises connecting the plurality of scan ICs to one scan electrode group selected from the group consisting of:
a first scan electrode group connected to odd-numbered scan electrode lines out of upper panel blocks on a basis of a horizontal direction center line of the plasma display panel;
a second scan electrode group connected to even-numbered scan electrode lines out of the upper panel blocks;
a third scan electrode group connected to odd-numbered scan electrode lines out of lower panel blocks on the basis of the horizontal direction center line;
and a fourth scan electrode group connected to even-numbered scan electrode lines out of the lower panel blocks.

12. The method according to claim 10, wherein the step of setting the plurality of first output control terminal groups comprises:
connecting first output control terminals in the scan ICs connected to odd-numbered scan electrode lines of the plasma display panel so as to set the first output control terminals to an output control terminal group A; and
connecting first output control terminals in the scan ICs connected to even-numbered scan electrode lines of the plasma display panel so as to set the first output control terminals to an output control terminal group B; and
wherein the step of setting the plurality of second output control terminal groups comprises:
connecting second output control terminals in the scan ICs connected to the scan electrode lines for connecting upper panel blocks on a basis of a horizontal direction center line of the plasma display panel so as to set the second output control terminals to an output control terminal group C; and
connecting second output control terminals in the scan ICs connected to the scan electrode lines for connecting lower panel blocks on the basis of the horizontal direction center line so as to set the second output control terminals to an output control terminal group D.

13. The method according to claim 10, wherein the step of setting the plurality of first output control terminal groups comprises:
connecting first output control terminals in the scan ICs connected to scan electrode lines for connecting upper panel blocks on a basis of a horizontal direction center line of the plasma display panel so as to set the first output control terminals to an output control terminal group A; and
connecting first output control terminals in the scan ICs connected to the scan electrode lines for connecting lower panel blocks on the basis of the horizontal direction center line so as to set the first output control terminals to an output control terminal group B; and
wherein the step of setting the plurality of second output control terminal groups comprises:
connecting second output control terminals in the scan ICs connected to odd-numbered scan electrode lines of the plasma display panel so as to set the second output control terminals to an output control terminal group C; and
connecting second output control terminals in the scan ICs connected to even-numbered scan electrode lines of the plasma display panel so as to set the second output control terminals to an output control terminal group B.

14. The method according to claim 10, wherein the step of applying the driving signal comprises applying a high level signal to one group out of the first output control terminal groups during the predetermined time, and applying a low level signal to another group out of the second output control terminal groups so as to turn on low side switches inside the scan ICs using the controller.
